(19) United States
(12) Patent Application Publication
(10) Pub. No.: US 2026/0230221 A1
(43) Pub. Date: Aug. 6, 2026

(54) Communication Method and Apparatus

(71) Applicant: HUAWEI TECHNOLOGIES CO., LTD., Shenzhen (CN)

(72) Inventors: Mingyue Zhou, Shenzhen (CN); Fan Wang, Shanghai (CN)

(73) Assignee: HUAWEI TECHNOLOGIES CO., LTD., Shenzhen (CN)

(21) Appl. No.: 19/631,273

(22) Filed: Mar. 27, 2026

Related U.S. Application Data
(63) Continuation of application No. PCT/CN2023/122780, filed on Sep. 28, 2023.

(51) Int. Cl. H04L 1/00; H04L 5/00; H04W 72/12

(52) U.S. Cl. CPC H04L 1/0042; H04L 5/0048; H04W 72/12

(57) ABSTRACT

In a method, M reference signals are indicated by segments of information (for example, first information) obtained by a terminal through error correction encoding. After the terminal sends the M reference signals to a network device on a scheduling-free resource, the M reference signals may change due to interference between different users when being received by the network device. However, because indication information of these reference signals is obtained through error correction encoding, the network device determines, based on the received reference signals, information indicating the reference signals, and performs error correction decoding on the information, to recover the first information. In this way, the network device can decode scheduling-free transmission by using the first information, so that decoding can still be performed when pilot resources used by different users for scheduling-free transmission collide.

### CROSS-REFERENCE TO RELATED APPLICATIONS

This is a continuation of International Patent Application No. PCT/CN2023/122780 filed on Sep. 28, 2023, the disclosure of which is hereby incorporated by reference in its entirety.

### TECHNICAL FIELD

This application relates to the field of communication technologies, and in particular, to a communication method and apparatus.

### BACKGROUND

Scheduling-free/Without dynamic grant (grant-free (GF)) transmission may be one of future transmission solutions for reducing a transmission latency. A common characteristic of scheduling-free transmission is that, before uplink transmission, a terminal does not need to monitor a dynamic grant of a base station to obtain time-frequency resources and transmission parameters used to send data, but sends data to the base station by using preconfigured time-frequency resources and transmission parameters. The preconfigured time-frequency resources and transmission parameters are usually configured by the base station by using higher layer signaling, for example, system information (SI) or user equipment (UE)-specific radio resource control (RRC) signaling.

It can be learned that scheduling-free transmission can eliminate signaling overheads and a latency caused by the dynamic grant, thereby improving transmission efficiency. However, due to the preconfiguration, a plurality of users usually share the preconfigured resources. When the plurality of users need to perform data transmission at the same time, resource contention occurs among the users, affecting data transmission of the users. For example, when pilot resources used by different users for scheduling-free transmission collide, a network side may be unable to distinguish between these users, and therefore cannot implement decoding.

### SUMMARY

Embodiments of this application provide a communication method and apparatus, so that a network can still implement decoding when pilot resources used by different users for scheduling-free transmission collide.

To achieve the foregoing objectives, this application uses the following technical solutions.

According to a first aspect, a communication method is provided. The method includes obtaining first information through error correction encoding, and determining M pieces of indication information. The M pieces of indication information indicate M reference signals corresponding to a scheduling-free resource, the M pieces of indication information are in a one-to-one correspondence with M segments, the M segments are obtained by dividing the first information into M segments, and M is an integer greater than 1. In this way, the M reference signals can be sent on the scheduling-free resource based on the M pieces of indication information.

It may be understood that the method according to the first aspect may be performed by a terminal, an apparatus including a terminal, or a chip in a terminal. This is not limited. For ease of description, the following uses an example in which the method is performed by a terminal for description.

In a possible design scheme, obtaining the first information through error correction encoding includes performing error correction encoding on a first to-be-encoded sequence to obtain the first information. For example, the error correction encoding may include at least one of the following: linear channel error correction encoding, nonlinear channel error correction encoding, or check coding. In other words, the error correction encoding may be single-stage error correction encoding, for example, linear channel error correction encoding or nonlinear channel error correction encoding, featuring lower coding complexity and requiring lower overheads. Alternatively, the error correction encoding may be concatenated multi-stage error correction encoding, featuring higher coding complexity and a stronger error correction capability.

Optionally, performing error correction encoding on the first to-be-encoded sequence to obtain the first information includes performing error correction encoding on the first to-be-encoded sequence based on a configuration parameter needed for error correction encoding, to obtain the first information. For example, the configuration parameter may indicate at least one of the following: a format of the to-be-encoded sequence, for example, an encoding input length, or a format of information obtained through error correction encoding, for example, an encoding output length.

It may be understood that, because the encoding input length and the encoding output length may be aligned in advance between the terminal and a network device, the terminal performs error correction encoding based on configuration information, for example, a predetermined encoding input length and encoding output length, to avoid decoding failure caused by an incorrect encoding format.

Optionally, the method according to the first aspect may further include receiving the first to-be-encoded sequence, to avoid processing overheads caused by self-determining, or determining the first to-be-encoded sequence by itself, to avoid generating additional communication overheads.

Further, determining the to-be-encoded sequence includes determining a sequence corresponding to to-be-sent data as the first to-be-encoded sequence, to reuse a reference signal for data transmission, thereby reducing data transmission overheads.

In a possible design scheme, the method according to the first aspect may further include receiving position information, where the position information indicates a position of the M segments in the first information. Correspondingly, determining the M pieces of indication information includes dividing the first information into M segments based on the position information, to obtain the M pieces of indication information, to avoid using an incorrect reference signal caused by a segmentation error.

It should be understood that the position information is optional information. If a segmentation rule is preconfigured in the terminal or predefined in a protocol, the terminal does not need to receive the position information.

In a possible design scheme, the scheduling-free resource includes M time-frequency resources, and each of the M time-frequency resources (for example, one or more resource blocks or one or more resource elements) is used to carry a corresponding reference signal in the M reference signals, to avoid a signal collision caused by one time-frequency resource carrying a plurality of reference signals.

Optionally, the method according to the first aspect may further include receiving a correspondence, for example, a one-to-one correspondence, between the M time-frequency resources and the M pieces of indication information, which means that the M time-frequency resources are in a one-to-one correspondence with the M pieces of indication information. Correspondingly, sending the M reference signals on the scheduling-free resource based on the M pieces of indication information includes sending the M reference signals on the M time-frequency resources based on the M pieces of indication information and the correspondence, to avoid signal demodulation failure caused by sending a reference signal on an incorrect time-frequency resource.

It should be understood that the correspondence is optional information. If the correspondence between the M time-frequency resources and the M pieces of indication information is preconfigured in the terminal or predefined in a protocol, the terminal does not need to additionally receive the correspondence.

In a possible design scheme, the first information includes N bit sequences, N is a positive integer, and the M segments are obtained by dividing a j^{th} bit sequence in the N bit sequences into mj segments, where j traverses 1 to N, and one bitmap included in each of the M segments is used as one piece of indication information. Compared with a bit padding manner, a bitmap may indicate more reference signals by using fewer bits.

For example, the j^{th} bit sequence may be expressed as:

$${c}_{j} = [ {c}_{p , 1} , … {c}_{p , i} … , {c}_{p , mj} ] ∈ {F}_{2}^{{CN}_{p} \times 1}$$

In the expression, cⱼ represents an i^{th} bit sequence, c_{p,i} represents an i^{th} bitmap, i is any integer from 1 to mj, F₂ represents a binary finite field, CNₚ represents that the i^{th} bitmap includes Nₚ bits, and Nₚ is an integer greater than 1.

Optionally, the bit sequence is any one of the following: an Reed-Muller (RM) code, a polar code, a low-density parity-check (LDPC) code, a hash code, or a cyclic redundancy check (CRC) code, or may be any possible code domain resource, which may be flexibly selected based on an actual situation. This is not limited.

According to a second aspect, a communication method is provided. The method includes receiving reference signals on a scheduling-free resource, and performing error correction decoding on information indicating the reference signals, to obtain first information, so as to decode scheduling-free transmission by using the first information. M segments are obtained by dividing the first information into M segments, the M segments are in a one-to-one correspondence with M pieces of indication information, the M pieces of indication information indicate that the reference signals received on the scheduling-free resource are M reference signals, and M is an integer greater than 1.

It may be understood that the method according to the second aspect may be performed by a network device, an apparatus including a network device, or a chip in a network device. This is not limited. For ease of description, the following uses an example in which the method is performed by a network device for description.

It can be learned from the methods in the first aspect and the second aspect that the M reference signals are indicated by segments of information (for example, the first information) obtained by a terminal through error correction encoding. After the terminal sends the M reference signals to the network device on the scheduling-free resource, the M reference signals may change due to interference between different users when being received by the network device. However, because the indication information of these reference signals is obtained through error correction encoding, the network device determines, based on the received reference signals, the information indicating the reference signals, and performs error correction decoding on the information, to recover the first information. In this way, the network device can decode scheduling-free transmission by using the first information, so that decoding can still be performed when pilot resources used by different users for scheduling-free transmission collide.

In a possible design scheme, before receiving the reference signals on the scheduling-free resource, the method according to the second aspect may further include performing error correction encoding on a first to-be-encoded sequence to obtain the first information; and sending the first information. In this way, a peer device does not need to perform error correction encoding, which facilitates energy saving.

Optionally, the method according to the second aspect may further include sending position information, where the position information may indicate a position of the M segments in the first information, to ensure that the peer device can correctly segment the first information, and avoid using an incorrect reference signal caused by a segmentation error.

In a possible design scheme, before receiving the reference signals on the scheduling-free resource, the method according to the second aspect may further include performing error correction encoding on a first to-be-encoded sequence to obtain the first information; dividing the first information into M segments, to obtain the M pieces of indication information; and sending the M pieces of indication information. In this way, the peer device neither needs to perform error correction encoding nor needs to perform a segmentation operation, which further facilitates energy saving.

In a possible design scheme, before receiving the reference signals on the scheduling-free resource, the method according to the second aspect may further include separately performing error correction encoding on a plurality of to-be-encoded sequences to obtain and send a plurality of pieces of information. The plurality of pieces of information include the first information, and the plurality of pieces of information respectively indicate the reference signals corresponding to the scheduling-free resource.

It may be understood that the plurality of pieces of information are usually information configured for a plurality of devices (for example, a plurality of terminals), and the plurality of pieces of information may be sent at a time. For example, the network device broadcasts the plurality of pieces of information, so that different terminals can separately obtain required information through a single broadcast. Compared with a manner of separately unicasting to the plurality of terminals, communication overheads can be reduced.

Optionally, the method according to the second aspect may further include sending an information index, where the information index indicates the first information in the plurality of pieces of information. In other words, the network device may alternatively determine which piece of information in the plurality of pieces of information is to be used by each of different terminals, to avoid a transmission collision caused by use of the same information by different terminals.

In a possible design scheme, before receiving the reference signals on the scheduling-free resource, the method according to the second aspect may further include sending a configuration parameter needed for error correction encoding.

Optionally, the configuration parameter may indicate at least one of the following: a format of the to-be-encoded sequence, or a format of information obtained through error correction encoding.

In a possible design scheme, the method according to the second aspect may include sending a first to-be-encoded sequence used for error correction encoding.

In a possible design scheme, the scheduling-free resource includes M time-frequency resources, and each of the M time-frequency resources is used to carry a corresponding reference signal in the M reference signals.

Optionally, before receiving the reference signals on the scheduling-free resource, the method according to the second aspect may further include sending a correspondence between the M time-frequency resources and the M pieces of indication information. Correspondingly, receiving the reference signals on the scheduling-free resource includes receiving the reference signals on the M time-frequency resources.

In a possible design scheme, the first information includes N bit sequences, N is a positive integer, and the M segments are obtained by dividing a j^{th} bit sequence in the N bit sequences into mj segments, where j traverses 1 to N, and one bitmap included in each of the M segments is used as one piece of indication information.

Optionally, the j^{th} bit sequence may be expressed as:

$${c}_{j} = [ {c}_{p , 1} , … {c}_{p , i} … , {c}_{p , mj} ] ∈ {F}_{2}^{{CN}_{p} \times 1}$$

In the expression, cⱼ represents an i^{th} bit sequence, c_{p,i} represents an i^{th} bitmap, i is any integer from 1 to mj, F₂ represents a binary finite field, CNₚ represents that the i^{th} bitmap includes Nₚ bits, and Nₚ is an integer greater than 1.

Optionally, the bit sequence may be any one of the following: an RM code, a polar code, a LDPC code, a hash code, or a CRC code.

In a possible design scheme, complexity of the error correction encoding is positively correlated with a quantity of devices (for example, a quantity of terminals) reusing the scheduling-free resource. In other words, the network device may determine complexity of the error correction encoding based on the quantity of terminals. For example, when the quantity of terminals is relatively large, a probability of resource collisions is higher, and the collisions are severer. The network device may indicate the terminal to perform more complex error correction encoding, or the network device itself performs more complex error correction encoding, for example, concatenated error correction encoding of multiple types, to achieve a stronger error correction capability, so as to handle a relatively severe resource collision. Conversely, when the quantity of terminals is relatively small, a probability of resource collisions is lower. The network device may indicate the terminal to perform simpler error correction encoding, or the network device itself performs simpler error correction encoding, to reduce overheads while ensuring an error correction capability.

In addition, for other technical effects of the method according to the second aspect, refer to the technical effects of the method according to the first aspect. Details are not described herein again.

According to a third aspect, a communication apparatus is provided. The communication apparatus includes a module configured to perform the method according to either of the first aspect and the second aspect, for example, a transceiver module and a processing module. For example, the transceiver module is configured to perform receiving and sending functions of the communication apparatus, and the processing module is configured to perform a function of the communication apparatus other than the receiving and sending functions.

In a possible implementation, the communication apparatus according to the third aspect includes a module configured to perform the method according to the first aspect, for example, a transceiver module and a processing module.

The processing module is configured to obtain first information through error correction encoding, and determine M pieces of indication information. The M pieces of indication information indicate M reference signals corresponding to a scheduling-free resource, the M pieces of indication information are in a one-to-one correspondence with M segments, the M segments are obtained by dividing the first information into M segments, and M is an integer greater than 1. In this way, the transceiver module is configured to send the M reference signals on the scheduling-free resource based on the M pieces of indication information.

In a possible design scheme, the processing module is further configured to perform error correction encoding on a first to-be-encoded sequence to obtain the first information. For example, the error correction encoding may include at least one of the following: linear channel error correction encoding, nonlinear channel error correction encoding, or check coding.

Optionally, the processing module is further configured to perform error correction encoding on the first to-be-encoded sequence based on a configuration parameter needed for error correction encoding, to obtain the first information. For example, the configuration parameter may indicate at least one of the following: a format of the to-be-encoded sequence, for example, an encoding input length, or a format of information obtained through error correction encoding, for example, an encoding output length.

Optionally, the transceiver module is further configured to receive the first to-be-encoded sequence, or the processing module is further configured to determine the first to-be-encoded sequence.

Further, the processing module is further configured to determine a sequence corresponding to to-be-sent data as the first to-be-encoded sequence.

In a possible design scheme, the transceiver module is further configured to receive position information, where the position information indicates a position of the M segments in the first information. Correspondingly, the processing module is further configured to divide the first information into M segments based on the position information, to obtain the M pieces of indication information.

In a possible design scheme, the scheduling-free resource includes M time-frequency resources, and each of the M time-frequency resources (for example, one or more resource blocks or one or more resource elements) is used to carry a corresponding reference signal in the M reference signals.

Optionally, the transceiver module is further configured to receive a correspondence between the M time-frequency resources and the M pieces of indication information. Correspondingly, the transceiver module is further configured to send the M reference signals on the M time-frequency resources based on the M pieces of indication information and the correspondence.

In a possible design scheme, the first information includes N bit sequences, N is a positive integer, and the M segments are obtained by dividing a j^{th} bit sequence in the N bit sequences into mj segments, where j traverses 1 to N, and one bitmap included in each of the M segments is used as one piece of indication information. Compared with a bit padding manner, a bitmap may indicate more reference signals by using fewer bits.

For example, the j^{th} bit sequence may be expressed as:

$${c}_{j} = [ {c}_{p , 1} , … {c}_{p , i} … , {c}_{p , mj} ] ∈ {F}_{2}^{{CN}_{p} \times 1}$$

In the expression, cⱼ represents an i^{th} bit sequence, c_{p,i} represents an i^{th} bitmap, i is any integer from 1 to mj, F₂ represents a binary finite field, CNₚ represents that the i^{th} bitmap includes Nₚ bits, and Nₚ is an integer greater than 1.

Optionally, the bit sequence is any one of the following: an RM code, a polar code, a LDPC code, a hash code, or a CRC code, or may be any possible code domain resource, which may be flexibly selected based on an actual situation. This is not limited.

In another possible implementation, the communication apparatus according to the third aspect includes a module configured to perform the method according to the second aspect, for example, a transceiver module and a processing module.

The transceiver module is configured to receive reference signals on a scheduling-free resource; and the processing module is configured to perform error correction decoding on information indicating the reference signals, to obtain first information, so as to decode scheduling-free transmission by using the first information. M segments are obtained by dividing the first information into M segments, the M segments are in a one-to-one correspondence with M pieces of indication information, the M pieces of indication information indicate that the reference signals received on the scheduling-free resource are M reference signals, and M is an integer greater than 1.

In a possible design scheme, before receiving the reference signals on the scheduling-free resource, the processing module is further configured to perform error correction encoding on a first to-be-encoded sequence to obtain the first information; and the transceiver module is further configured to send the first information.

Optionally, the transceiver module is further configured to send position information, where the position information may indicate a position of the M segments in the first information.

In a possible design scheme, before receiving the reference signals on the scheduling-free resource, the processing module is further configured to perform error correction encoding on a first to-be-encoded sequence to obtain the first information, and divide the first information into M segments, to obtain the M pieces of indication information; and the transceiver module is further configured to send the M pieces of indication information.

In a possible design scheme, before receiving the reference signals on the scheduling-free resource, the processing module is further configured to separately perform error correction encoding on a plurality of to-be-encoded sequences to obtain a plurality of pieces of information; and the transceiver module is further configured to send the plurality of pieces of information. The plurality of pieces of information include the first information, and the plurality of pieces of information respectively indicate the reference signals corresponding to the scheduling-free resource.

Optionally, the transceiver module is further configured to send an information index, where the information index indicates the first information in the plurality of pieces of information.

In a possible design scheme, before receiving the reference signals on the scheduling-free resource, the transceiver module is further configured to send a configuration parameter needed for error correction encoding.

Optionally, the configuration parameter may indicate at least one of the following: a format of the to-be-encoded sequence, or a format of information obtained through error correction encoding.

In a possible design scheme, the transceiver module is further configured to send a first to-be-encoded sequence used for error correction encoding.

In a possible design scheme, the scheduling-free resource includes M time-frequency resources, and each of the M time-frequency resources is used to carry a corresponding reference signal in the M reference signals.

Optionally, before receiving the reference signals on the scheduling-free resource, the transceiver module is further configured to send a correspondence between the M time-frequency resources and the M pieces of indication information. Correspondingly, the transceiver module is further configured to receive the reference signals on the M time-frequency resources.

In a possible design scheme, the first information includes N bit sequences, N is a positive integer, and the M segments are obtained by dividing a j^{th} bit sequence in the N bit sequences into mj segments, where j traverses 1 to N, and one bitmap included in each of the M segments is used as one piece of indication information.

Optionally, the j^{th} bit sequence may be expressed as:

$${c}_{j} = [ {c}_{p , 1} , … {c}_{p , i} … , {c}_{p , mj} ] ∈ {F}_{2}^{{CN}_{p} \times 1}$$

In the expression, cⱼ represents an i^{th} bit sequence, c_{p,i} represents an i^{th} bitmap, i is any integer from 1 to mj, F₂ represents a binary finite field, CNₚ represents that the i^{th} bitmap includes Nₚ bits, and Nₚ is an integer greater than 1.

Optionally, the bit sequence may be any one of the following: an RM code, a polar code, a LDPC code, a hash code, or a CRC code.

In a possible design scheme, complexity of the error correction encoding is positively correlated with a quantity of devices reusing the scheduling-free resource.

Optionally, the transceiver module may include a sending module and a receiving module. The sending module is configured to implement a sending function of the communication apparatus according to the third aspect, and the receiving module is configured to implement a receiving function of the communication apparatus according to the third aspect.

Optionally, the communication apparatus according to the third aspect may further include a storage module, and the storage module stores a program or instructions. When the processing module executes the program or the instructions, the communication apparatus is enabled to perform the method according to either of the first aspect and the second aspect.

It may be understood that the communication apparatus according to the third aspect may be a terminal or a network device, may be a chip (system) or another part or component that may be disposed in a terminal or a network device, or may be an apparatus that includes a terminal or a network device. This is not limited in this application.

In addition, for technical effects of the communication apparatus according to the third aspect, refer to the technical effects of the foregoing other aspects. Details are not described herein again.

According to a fourth aspect, a communication apparatus is provided. The communication apparatus includes a processor, and the processor is configured to perform the method according to either of the first aspect and the second aspect.

In a possible design scheme, the communication apparatus according to the fourth aspect may further include a transceiver. The transceiver may be a transceiver circuit or an interface circuit. The transceiver may be used by the communication apparatus according to the fourth aspect to communicate with another communication apparatus.

In a possible design scheme, the communication apparatus according to the fourth aspect may further include a memory. The memory and the processor may be integrated together, or may be disposed separately. The memory may be configured to store a computer program and/or data in the method according to either of the first aspect and the second aspect.

In embodiments of this application, the communication apparatus according to the fourth aspect may be the terminal or the network device according to either of the first aspect and the second aspect, a chip (system) or another part or component that may be disposed in the terminal or the network device, or an apparatus that includes the terminal or the network device.

In addition, for technical effects of the communication apparatus according to the fourth aspect, refer to the technical effects of the method according to either of the first aspect and the second aspect. Details are not described herein again.

According to a fifth aspect, a communication apparatus is provided. The communication apparatus includes a processor. The processor is coupled to a memory. The processor is configured to execute a computer program stored in the memory, to enable the communication apparatus to perform the method according to either of the first aspect and the second aspect.

In a possible design scheme, the communication apparatus according to the fifth aspect may further include a transceiver. The transceiver may be a transceiver circuit or an interface circuit. The transceiver may be used by the communication apparatus according to the fifth aspect to communicate with another communication apparatus.

In embodiments of this application, the communication apparatus according to the fifth aspect may be the terminal or the network device according to either of the first aspect and the second aspect, a chip (system) or another part or component that may be disposed in the terminal or the network device, or an apparatus that includes the terminal or the network device.

In addition, for technical effects of the communication apparatus according to the fifth aspect, refer to the technical effects of the method according to either of the first aspect and the second aspect. Details are not described herein again.

According to a sixth aspect, a communication apparatus is provided, including a processor and a memory. The memory is configured to store a computer program. When the processor executes the computer program, the communication apparatus is enabled to perform the method according to either of the first aspect and the second aspect.

In a possible design scheme, the communication apparatus according to the sixth aspect may further include a transceiver. The transceiver may be a transceiver circuit or an interface circuit. The transceiver may be used by the communication apparatus according to the sixth aspect to communicate with another communication apparatus.

In embodiments of this application, the communication apparatus according to the sixth aspect may be the terminal or the network device according to either of the first aspect and the second aspect, a chip (system) or another part or component that may be disposed in the terminal or the network device, or an apparatus that includes the terminal or the network device.

In addition, for technical effects of the communication apparatus according to the sixth aspect, refer to the technical effects of the method according to either of the first aspect and the second aspect. Details are not described herein again.

According to a seventh aspect, a chip is provided. The chip includes a controller and an interface circuit. The controller is configured to interact with another apparatus by using the interface circuit, to perform the method according to either of the first aspect and the second aspect.

According to an eighth aspect, a communication system is provided. The communication system includes a terminal configured to perform the method according to the first aspect and a network device configured to perform the method according to the second aspect.

According to a ninth aspect, a computer-readable storage medium is provided, including a computer program or instructions. When the computer program or the instructions are run on a computer, the computer is enabled to perform the method according to either of the first aspect and the second aspect.

According to a tenth aspect, a computer program product is provided, including a computer program or instructions. When the computer program or the instructions are run on a computer, the computer is enabled to perform the method according to either of the first aspect and the second aspect.

### BRIEF DESCRIPTION OF DRAWINGS

FIG. 1 is a pilot pattern 1 of scheduling-free resource;

FIG. 2 is a pilot pattern 2 of scheduling-free resource;

FIG. 3 is a diagram of an architecture of a communication system according to an embodiment of this application;

FIG. 4 is a schematic flowchart 1 of a communication method according to an embodiment of this application;

FIG. 5 is a pattern of reference signals before error correction in a communication method according to an embodiment of this application;

FIG. 6 is a pattern of reference signals after error correction in a communication method according to an embodiment of this application;

FIG. 7 is a diagram 1 of a structure of a communication apparatus according to an embodiment of this application; and

FIG. 8 is a diagram 2 of a structure of a communication apparatus according to an embodiment of this application.

### DESCRIPTION OF EMBODIMENTS

The technical solutions in embodiments of this application may be applied to various communication systems, for example, a Wi-Fi system, an ultra-wideband (UWB) system, a vehicle-to-everything (V2X) communication system, a device-to-device (D2D) communication system, an Internet of vehicles (IoV) communication system, a 4th generation (4G) mobile communication system such as a Long-Term Evolution (LTE) system and a Worldwide Interoperability for Microwave Access (WiMAX) communication system, 5G such as a new radio (NR) system, and a future communication system (5.5G or sixth generation (6G)).

For ease of understanding, technical terms in embodiments of this application are described first below.

### 1. Scheduling-Free/without Dynamic Grant Transmission:

Scheduling-free transmission may be one of future transmission solutions for reducing a transmission latency. The scheduling-free transmission mainly includes two types. One type is that a terminal completes uplink data transmission during random access, for example, in a 2-step random access (2-step RA) procedure introduced in a 5G mobile communication system, that is, a NR system. The other type is that a terminal directly performs uplink data transmission, for example, semi-persistent scheduling (SPS) in an LTE system, transmission based on a preconfigured uplink resource (PUR), and transmission based on a configured grant (CG) in NR. A common characteristic of the two types of scheduling-free transmission is that, before performing uplink transmission, a terminal does not need to monitor a dynamic grant of a base station to obtain time-frequency resources and transmission parameters used to send data, but sends data to the base station by using preconfigured time-frequency resources and preconfigured transmission parameters. The preconfigured time-frequency resources and transmission parameters are usually configured by the base station by using higher layer signaling, for example, SI or UE-specific RRC signaling. A difference between the two types of scheduling-free transmission lies in that, for 2-step random access, the terminal further needs to send a random-access preamble to the base station when sending data. In other words, the data of the terminal and the random-access preamble are in a same uplink message, and the uplink message is used for uplink synchronization between the terminal and the base station. However, when the terminal directly performs uplink data transmission, the terminal does not need to send a random-access preamble to the base station. In other words, the direct transmission solution is more applicable to a case in which the terminal and the base station have completed uplink synchronization.

It can be learned that scheduling-free transmission can eliminate signaling overheads and a latency caused by the dynamic grant, thereby improving transmission efficiency. However, because of the preconfiguration, a plurality of users usually share the preconfigured resources. When the plurality of users need to perform data transmission at the same time, resource contention occurs among the users, affecting data transmission of the users. Especially, when a user and another user use a same time-frequency resource and a same pilot (port and sequence) to access a scheduling-free resource, a collision is relatively severe. In this case, because pilots of the plurality of users are consistent, the base station may be unable to identify and distinguish between the plurality of users by using the pilots, and therefore, cannot obtain channel state information (CSI) of the users, and cannot implement signal demodulation. Even if the base station can detect the colliding pilot, usually, only one user can use the pilot by default, and subsequent demodulation is performed according to a demodulation mode of the single user. In other words, a pilot collision usually means that only a maximum of one user using the pilot can perform transmission properly, and other users fail to perform transmission. Therefore, the pilot collision is a performance bottleneck that constrains a scheduling-free transmission solution.

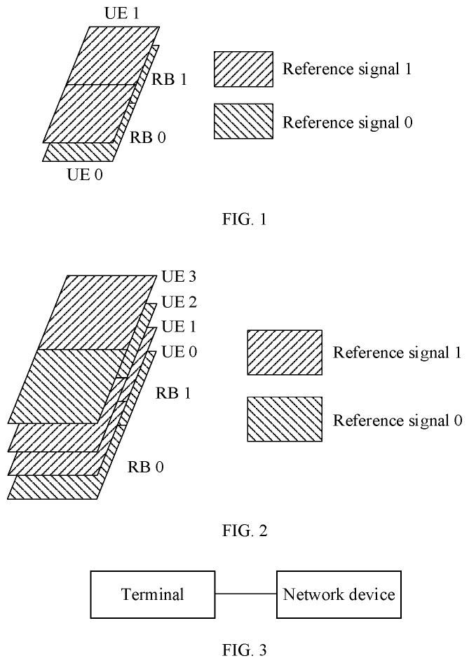

To reduce collisions, an existing solution (denoted as a solution 1) is to expand pilot resources to reduce a possibility of collisions. In other words, if more pilots are available for selection by a terminal, a probability of pilot collisions is lower. For example, different users are allocated different pilots, and a quantity of pilots to be allocated corresponds to a quantity of users. As shown in FIG. 1, a UE 0 is allocated a pilot 0 on a resource block (RB) 0 and an RB 1, and a UE 1 is allocated a pilot 1 on the RB 0 and the RB 1. In this case, for a pilot k in a plurality of pilots, a least square (least square, LS) channel estimation output may be shown in the following formula 1:

$$y = {b}_{0} {h}_{0} {s}_{0} + {b}_{1} {h}_{1} {s}_{1} + n \qquad ( 1 )$$

In the formula, when

$${s}_{1} {s}_{0}^{H} \neq 0 ,$$

that is, when the pilot 1 and the pilot 0 are not orthogonal to each other, h₁ leaks into h₀. In this case, the following problems are caused.

If b₀=0, and b₁=1, that is, when the UE 0 does not perform sending, and the UE 1 performs sending, h₁ leaks into h₀. When leakage energy is sufficiently high, that is, when ∥ĥ₀∥ is greater than an activity detection threshold Th, a base station considers that s₀ is sent, causing a false alarm for the UE 0. If b₀=1, and b₁=1, that is, when the UE 0 performs sending, and the UE 1 performs sending, h₁ leaks into ĥ₀. When h₁ and h₀ are in a mutual cancellation relationship, ∥ĥ₀∥ may be caused to fall below the detection threshold Th, and the base station considers that s₀ is not sent, causing missed detection for the UE 0. Similarly, because

$${s}_{1} {s}_{0}^{H} \neq 0 ,$$

the UE 1 is also affected by the UE 0, and detection performance is degraded (that is, there is a possibility of a false alarm or missed detection). In other words, a pilot leakage and a false alarm or missed detection caused by the pilot leakage can be avoided only when the pilot 0 is orthogonal to the pilot 1, that is, when

$${s}_{1} {s}_{0}^{H} = 0 .$$

However, orthogonal pilot resources are limited. Therefore, a quantity of users supported by the solution 1 is limited. For example, N orthogonal pilots can carry only N users, and actual application of the solution 1 is limited.

Similarly, to reduce collisions, another existing solution (denoted as a solution 2) is to configure a pilot pattern when different users are allocated different pilots, so that more pilots are implemented, or in other words, a pilot pattern may use fewer pilots to support more users. For example, as shown in FIG. 2, a UE 0 is allocated a pilot 0 on an RB 0 and an RB 1, a UE 1 is allocated a pilot 1 on the RB 0 and the RB 1, a UE 2 is allocated the pilot 0 on the RB 0 and use the pilot 1 on the RB 1, and a UE 3 is allocated the pilot 1 on the RB 0 and use the pilot 0 on the RB 1. In other words, scheduling-free transmission of four UEs is implemented by using two pilots.

However, the solution 2 also has the same problems as the solution 1. FIG. 2 is used as an example. It is assumed that the base station detects ∥ĥ₀∥≥Th on both the RB 0 and the RB 1, that is, it is considered that the pilot 0 is detected as active (active). In this case, the base station may consider, based on the pilot pattern shown in FIG. 2, that the UE 0 is active, or consider that the UE 0 has sent the pilot 0. However, it is difficult to determine whether the UE 2 is active. For example, the UE 2 actually does not send the pilot 0 on the RB 0, but the pilot 0 sent by the UE 1 on the RB 0 leaks. As a result, the base station considers that the UE 2 has sent the pilot 0 on the RB 0, that is, a false alarm is generated. For another example, the UE 2 actually sends the pilot 1 on the RB 1, but because of poor transmission quality, the base station does not detect the pilot 1 on the RB 1, that is, missed detection occurs. In other words, due to overlapping pilot patterns of the users in the foregoing figure, decision ambiguity arises. As a result, false alarms are more likely to occur, and missed detection may also occur. In addition, such errors of false alarms and missed detection are brought by the base station into an overall pilot pattern decision, and severer error propagation occurs.

Understandably, different pilots may be understood as different pilot ports, or understood as belonging to different pilot ports. In addition, the pilot mentioned in embodiments of this application may also be understood as a reference signal.

In view of the foregoing technical problems, embodiments of this application provide the following technical solutions. The following describes technical solutions of this application with reference to accompanying drawings.

In embodiments of this application, “indication” may include a direct indication and an indirect indication, or may include an explicit indication and an implicit indication. Information indicated by a piece of information (for example, the following second indication information, first indication information, or second indication information) is referred to as to-be-indicated information. In a specific implementation process, there are a plurality of manners for indicating the to-be-indicated information, for example, but not limited to, directly indicating the to-be-indicated information, for example, indicating the to-be-indicated information itself or an index of the to-be-indicated information. Alternatively, the to-be-indicated information may be indirectly indicated by indicating other information, and an association relationship exists between the other information and the to-be-indicated information. Alternatively, only a part of the to-be-indicated information may be indicated, and the other part of the to-be-indicated information is known or prescribed. For example, specific information may alternatively be indicated by using an arrangement order of a plurality of pieces of information that is prescribed (for example, specified in a protocol), to reduce indication overheads to some extent. In addition, a common part of all pieces of information may be identified and indicated in a unified manner, to reduce indication overheads caused by separately indicating same information.

Furthermore, specific indication manners may alternatively be various existing indication manners, for example, but not limited to, the foregoing indication manners and various combinations thereof. For details of the various indication manners, refer to an existing related technology. Details are not described in this specification. It can be learned from the foregoing descriptions that, for example, when a plurality of pieces of information of a same type need to be indicated, different information may be indicated in different manners. In a specific implementation process, a required indication manner may be selected based on a specific requirement. The selected indication manner is not limited in embodiments of this application. In this way, the indication manner in embodiments of this application should be understood as covering various methods that can enable a to-be-indicated party to learn of to-be-indicated information.

It should be understood that the to-be-indicated information may be sent as a whole, or may be divided into a plurality of pieces of sub-information for separate sending. In addition, sending periodicities and/or sending occasions of these pieces of sub-information may be the same or different. A specific sending method is not limited in embodiments of this application. The sending periodicities and/or the sending occasions of these pieces of sub-information may be predefined, for example, predefined according to a protocol, or may be configured by a transmit end device by sending configuration information to a receive end device.

“Predefinition” or “preconfiguration” may be implemented by prestoring corresponding code or a corresponding table in a device, or may be implemented in another manner that may be used for indicating related information. A specific implementation thereof is not limited in embodiments of this application. “Storage” may be storage in one or more memories. The one or more memories may be separately disposed, or may be integrated into an encoder or a decoder, a processor, or a communication apparatus. Alternatively, the one or more memories may be partially disposed separately, and partially integrated into a decoder, a processor, or a communication apparatus. A type of the memory may be a storage medium in any form. This is not limited in embodiments of this application.

A “protocol” in embodiments of this application may be a protocol family in the communication field, a standard protocol with a frame structure similar to that in the protocol family, or a related protocol applied to a future communication system. This is not specifically limited in embodiments of this application.

In embodiments of this application, descriptions such as “when . . . ”, “in a case of . . . ”, and “if” all mean that a device performs corresponding processing in an objective case, and are not intended to limit time, and the device is not required to perform a determining action during implementation, and do not mean any other limitation.

In descriptions of embodiments of this application, unless otherwise specified, “/” means an “or” relationship between associated objects. For example, A/B may represent A or B. In embodiments of this application, “and/or” describes only an association relationship between associated objects, and indicates that three relationships may exist. For example, A and/or B may represent three cases: Only A exists, both A and B exist, and only B exists, where A and B may be singular or plural. In addition, in the descriptions of embodiments of this application, unless otherwise specified, “a plurality of” means two or more. The term “at least one of the following items (pieces)” or an expression similar to the term indicates any combination of these items, including a singular item (piece) or any combination of plural items (pieces). For example, at least one item (piece) of a, b, or c may indicate a, b, c, a and b, a and c, b and c, or a, b, and c, where a, b, and c may be singular or plural. In addition, to clearly describe the technical solutions in embodiments of this application, terms such as “first” and “second” are used in embodiments of this application to distinguish between same items or similar items having basically same functions and purposes. A person skilled in the art may understand that the terms such as “first” and “second” do not limit a quantity or an execution order, and the terms such as “first” and “second” do not indicate a definite difference. In addition, in embodiments of this application, the term “example”, “for example”, or the like represents an example, an illustration, or a description. Any embodiment or design scheme described as “example” or “for example” in embodiments of this application should not be construed as being more preferred or advantageous than another embodiment or design scheme. Exactly, use of the terms such as “example” or “for example” is intended to present a related concept in a specific manner for ease of understanding.

A network architecture and a service scenario described in embodiments of this application are intended to describe the technical solutions in embodiments of this application more clearly, and do not constitute any limitation on the technical solutions provided in embodiments of this application. A person of ordinary skill in the art may know that, with evolution of the network architecture and emergence of a new service scenario, the technical solutions provided in embodiments of this application are also applicable to a similar technical problem.

For ease of understanding embodiments of this application, a communication system shown in FIG. 3 is first used as an example to describe in detail a communication system to which embodiments of this application are applicable. For example, FIG. 3 is a diagram of an architecture of a communication system to which a communication method according to embodiments of this application is applicable.

As shown in FIG. 3, the communication system may include a terminal and a network device.

The terminal may also be referred to as a UE, an access terminal, a subscriber unit, a subscriber station, a mobile station (MS), a remote station, a remote terminal, a mobile device, a user terminal, a terminal, a wireless communication device, a user agent, or a user apparatus. The terminal in embodiments of this application may be a mobile phone, a cellular phone, a smartphone, a tablet computer (Pad), a wireless data card, a personal digital assistant (PDA) computer, a wireless modem, a handheld device, a laptop computer, a machine type communication (MTC) terminal, a computer having wireless receiving and sending functions, a virtual reality (VR) terminal, an augmented reality (AR) terminal, a smart home device (for example, a refrigerator, a television, an air conditioner, or a meter), a smart robot, a robot arm, a workshop device, a wireless terminal in industrial control, a wireless terminal in self driving, a wireless terminal in telemedicine (remote medical), a wireless terminal in a smart grid, a wireless terminal in transportation safety, a wireless terminal in a smart city, a wireless terminal in a smart home, a vehicle-mounted terminal, a road side unit (RSU) or the like having a terminal function, a flight device (for example, a smart robot, a hot air balloon, an uncrewed aerial vehicle, or an airplane), or the like. The terminal in this application may alternatively be a vehicle-mounted module, a vehicle-mounted assembly, a vehicle-mounted component, a vehicle-mounted chip, or a vehicle-mounted unit that is disposed in a vehicle as one or more components or units. The terminal device may alternatively be another device having a terminal function. For example, the terminal device may alternatively be a device that functions as a terminal in D2D communication.

The terminal in embodiments of this application may be a single terminal, or may be a terminal in a group scenario, that is, the terminal is a member in a group. A group may be a combination of members with same attributes. For example, the group may be a combination of members that can enjoy consistent services provided by an application network element, or may be a combination of all terminal devices located in a specified area. The group may be a 5G local area network (LAN), also referred to as a 5G virtual network (VN), or another type of group, for example, a temporary group or a dynamic group (a group in which group members need to be dynamically managed). This is not specifically limited herein.

A device form of the terminal is not limited in embodiments of this application. An apparatus for implementing a function of the terminal may be the terminal, or may be an apparatus, for example, a chip system, that can support the terminal in implementing the function. The apparatus may be mounted in the terminal or used in combination with the terminal. In embodiments of this application, the chip system may include a chip or may include a chip and another discrete component.

The network device may be a radio access network (RAN) device, also referred to as an access network apparatus. The access network apparatus may be further an access network device such as a sixth generation (6G) base station in a next-generation mobile communication system such as 6G, or the access network apparatus may have another name in a next-generation mobile communication system, both of which fall within the protection scope of embodiments of this application. This is not limited in this application. Alternatively, the access network apparatus may include a gNB in 5G, for example, a NR system, may include one or a group of antenna panels (including a plurality of antenna panels) of a base station in 5G, or may be a network node that forms a gNB, a transmission point (transmission and reception point (TRP)), or a transmission measurement function (TMF), for example, a central unit (CU), a distributed unit (DU), a CU-control plane (CP), or a CU-user plane (UP), a radio unit (RU), an RSU having a base station function, a wired access gateway, or a 5G core network element. Alternatively, the access network apparatus may further include an access point (AP) in a Wi-Fi system, a wireless relay node, a wireless backhaul node, various forms of macro base stations, a micro base station (also referred to as a small cell), a relay station, an access point, a wearable device, a vehicle-mounted device, or the like.

The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). It may be understood that the network device may be a CU node, a DU node, or a device including a CU node and a DU node. In addition, the CU may be classified as a network device in an access network RAN, or the CU may be classified as a network device in a core network CN. This is not limited herein.

In different systems, the CU (or the CU-CP and the CU-UP), the DU, or the RU may also have different names, but a person skilled in the art may understand meanings thereof. For example, in an ORAN system, the CU may also be referred to as an open CU (O-CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP and the CU-UP), the DU, and the RU in this application may be implemented by using a software module, a hardware module, or a combination of a software module and a hardware module.

A device form of the network device is not limited in embodiments of this application. An apparatus for implementing a function of the network device may be the network device, or may be an apparatus, for example, a chip system, that can support the network device in implementing the function. The apparatus may be mounted in the network device or used in combination with the network device. In embodiments of this application, the chip system may include a chip or may include a chip and another discrete component.

In the communication system, information indicating a reference signal, for example, M pieces of indication information indicating M reference signals corresponding to a scheduling-free resource, may be information obtained through error correction encoding, where M is an integer greater than 1. In this way, after the terminal sends the M reference signals on the scheduling-free resource based on the M pieces of indication information, the network device may determine, based on the reference signals received on the scheduling-free resource, information corresponding to the reference signals, and perform error correction decoding on the information, to recover the M pieces of indication information, so as to determine that the terminal sends the M reference signals. Therefore, a burst error can be resisted, error propagation can be reduced, and false alarms and missed detection can be avoided.

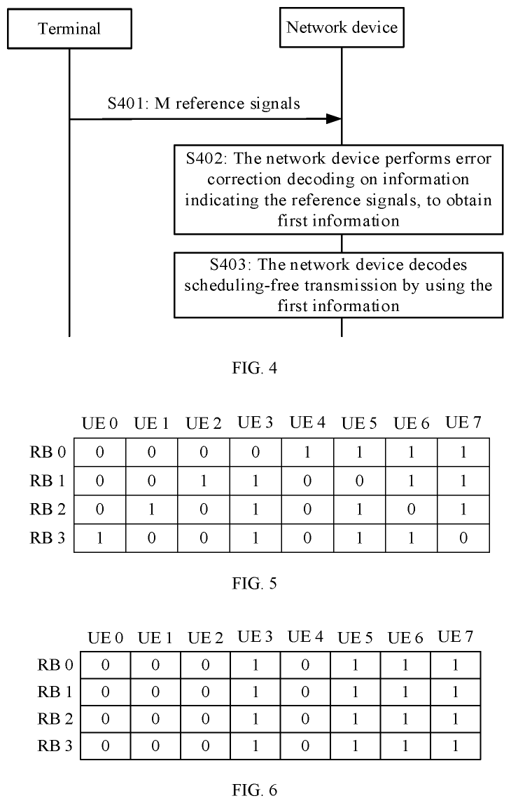

With reference to FIG. 4 to FIG. 6, the following describes in detail an interaction procedure between network elements or devices in the foregoing communication system by using method embodiments. The communication method provided in embodiments of this application is applicable to the foregoing communication system, and is further applied to various scenarios mentioned in the foregoing communication system. The following provides detailed descriptions.

FIG. 4 is a schematic flowchart of a communication method according to an embodiment of this application. The communication method is applicable to the foregoing communication system, and mainly relates to interaction between a terminal and a network device. As shown in FIG. 4, a procedure of the communication method is as follows.

S401: The terminal sends M reference signals on a scheduling-free resource based on M pieces of indication information. Correspondingly, the network device receives the reference signals on the scheduling-free resource.

The M pieces of indication information may indicate the M reference signals corresponding to the scheduling-free resource. The M pieces of indication information may be included in first information obtained through error correction encoding. For example, the first information is divided into M segments to obtain the M segments, where the M segments are in a one-to-one correspondence with the M pieces of indication information, and Mis an integer greater than 1. After the terminal sends the M reference signals, because the M reference signals may change due to interference between different users in a transmission process, when receiving the reference signals, the network device cannot determine a specific terminal from which the reference signals come.

S402: The network device performs error correction decoding on the information indicating the reference signals, to obtain the first information.

The network device may determine information, for example, a bitmap, that indicates each received reference signal. The network device may combine these bitmaps to obtain one or more bit sequences. The network device may obtain the first information by performing error correction decoding on the bit sequences.

S403: The network device decodes scheduling-free transmission by using the first information.

After the network device obtains the first information by performing error correction decoding, the network device may decode, by using the first information, data transmitted in the scheduling-free transmission, for example, data sent by the terminal in the scheduling-free transmission. In this case, if a decoding error occurs, the network device may send an error indication, to trigger the terminal to perform retransmission.

In conclusion, because the first information obtained through error correction encoding may indicate the M reference signals corresponding to the scheduling-free resource, after the terminal sends the M reference signals on the scheduling-free resource, the network device may determine, based on the reference signals received on the scheduling-free resource, the information corresponding to the reference signals, and perform error correction encoding on the information, to recover the first information. Therefore, a burst error can be resisted, error propagation can be reduced, and false alarms and missed detection can be avoided.

The following describes S401 and S402 in detail.

S401: (1) First information

The first information may include N bit sequences, or pilot bit sequences, or reference signal bit sequences, where N is a positive integer. Each bit sequence may be a related bit sequence obtained through error correction encoding. The error correction encoding may be represented by using a coding function [symbol] (·), and include at least one of the following: linear channel error correction encoding, nonlinear channel error correction encoding, or check coding. In other words, the error correction encoding may be single-stage error correction encoding, for example, linear channel error correction encoding or nonlinear channel error correction encoding, featuring lower coding complexity and requiring lower overheads. Alternatively, the error correction encoding may be concatenated multi-stage error correction encoding, featuring higher coding complexity and a stronger error correction capability.

For example, linear channel error correction encoding is concatenated with nonlinear channel error correction encoding. First, nonlinear channel error correction encoding is performed on an initial sequence to obtain an intermediate result, and then linear channel error correction encoding is performed on the intermediate result to obtain a bit sequence. The linear channel error correction encoding may include any one of the following: an RM code, a polar code, and an LDPC code. For another example, the nonlinear channel error correction encoding may include a hash code. The check coding may include a CRC code.

### (2) M Pieces of Indication Information

The M segments are obtained by dividing a j^{th} bit sequence in the N bit sequences into mj segments, where j traverses 1 to N, and one bitmap included in each of the M segments is used as one piece of indication information, to indicate a corresponding reference signal in the M reference signals, for example, indicate an index (or an identifier) of the reference signal. Compared with a bit padding manner, a bitmap may indicate more reference signals by using fewer bits.

For example, an example of the j^{th} bit sequence may be represented by using the following formula 2:

$${c}_{j} = [ {c}_{p , 1} , … {c}_{p , i} … , {c}_{p , mj} ] ∈ {F}_{2}^{{CN}_{p} \times 1} \qquad ( 2 )$$

In the formula, cⱼ may represent the j^{th} bit sequence; mj may represent that the j^{th} bit sequence is divided into mj segments, that is, mj bitmaps; and if N=1, mj=M·c_{p,i} may be an identifier (or a segment number) of an i^{th} bitmap of the mj bitmaps, and is used to represent the i^{th} bitmap, that is, an i^{th} piece of indication information, where i is any integer from 1 to mj. F₂ may represent a binary finite field formed by {0, 1}, CNₚ may represent Nₚ bits included in the i^{th} bitmap, and Nₚ may be an integer greater than 1. If one reference signal is carried on one time-frequency resource, Nₚ may represent that the time-frequency resource can support 2^{N}^{ₚ} ports, or in a case of spatial layering, a maximum of 2^{N}^{ₚ} different reference signals can be multiplexed on one time-frequency resource in single transmission.

It may be understood that when N is greater than 1, different bit sequences may have different quantities of segments, but lengths of the segments should be the same. For example, N=2, a bit sequence #1 includes eight bits and is divided into two segments, where each segment is a bitmap of four bits; and a bit sequence #2 includes 16 bits and is divided into four segments, where each segment is also a bitmap of four bits.

The scheduling-free resource are resources preconfigured or predefined in a protocol for use by the terminal. The scheduling-free resource may include M time-frequency resources, and each of the M time-frequency resources (for example, one or more RBs or one or more resource elements (REs)) may be used to carry a corresponding reference signal in the M reference signals, to avoid a signal collision caused by one time-frequency resource carrying a plurality of reference signals. There may be a correspondence, for example, a one-to-one correspondence, between the M pieces of indication information and the M time-frequency resources, that is, the M time-frequency resources are in a one-to-one correspondence with the M pieces of indication information, so that the terminal can map the M reference signals indicated by the M pieces of indication information to the M time-frequency resources.

For example, the network device may send the correspondence between the M time-frequency resources and the M pieces of indication information, and correspondingly, the terminal may receive the correspondence. In this way, the terminal may send the M reference signals on the M time-frequency resources based on the correspondence. Correspondingly, the network device may receive the reference signals on the M time-frequency resources, to avoid signal reception and demodulation failure caused by sending the reference signals on incorrect time-frequency resources.

It should be understood that the correspondence is optional information. If the correspondence between the M time-frequency resources and the M pieces of indication information is preconfigured in the terminal or predefined in a protocol, the network device does not need to additionally sends the correspondence, and the terminal does not need to additionally receive the correspondence.

For ease of understanding, the following uses an example for description.

If N=1, there is one bit sequence with a length of 16 bits, for example, 0011010011011111. M=4 indicates that the bit sequence needs to be divided into four segments, that is, four pieces of indication information, or indicates that one terminal may separately use four reference signals on four time-frequency resources. A bitmap corresponding to four bits in each segment may indicate a corresponding reference signal, for example, 0011, 0100, 1101, and 1111. 0011 is converted into 3 in decimal notation, indicating a reference signal with an index of 3, denoted as a reference signal 3. Similarly, 0100 is converted into 4 in decimal notation, indicating a reference signal 4. Similarly, 1101 is converted into 13 in decimal notation, indicating a reference signal 13. Similarly, 1111 is converted into 15 in decimal notation, indicating a reference signal 15. In other words, the four pieces of indication information indicate the terminal to separately reuse the reference signals on the four time-frequency resources: the reference signal 3, the reference signal 4, the reference signal 13, and the reference signal 15.

If N=2, there are two bit sequences, each with a length of eight bits, for example, a bit sequence #1:00110100, and a bit sequence #2:11011111. m1=2 indicates that the bit sequence #1 needs to be divided into two segments, that is, two pieces of indication information, for example, 0011 and 0100. m2=2 indicates that the bit sequence #2 needs to be divided into two segments, that is, two pieces of indication information, for example, 1101 and 1111. In this way, four pieces of indication information are obtained in total, so that the terminal separately reuses reference signals on four time-frequency resources: a reference signal 3, a reference signal 4, a reference signal 13, and a reference signal 15.

In this way, an example of a correspondence between the four pieces of indication information and the four time-frequency resources may be shown in Table 1.

TABLE 1

| Indication information | Time-frequency resource |
|---|---|
| 0011 | RB 1 |
| 0100 | RB 2 |
| 1101 | RB 3 |
| 1111 | RB 4 |
| . . . | . . . |

As shown in Table 1, 0011 indicates the reference signal 3, that is, the reference signal 3 is mapped to the RB 1, or the reference signal is carried by the RB 1. 0100 indicates the reference signal 4, that is, the reference signal 4 is mapped to the RB 2. 1101 indicates the reference signal 13, that is, the reference signal 13 is mapped to the RB 3. 1111 indicates the reference signal 15, that is, the reference signal 15 is mapped to the RB 4.

The foregoing describes definitions of the first information and the M pieces of indication information. The following describes in detail how the terminal obtains the first information or the M pieces of indication information. For example, the first information or the M pieces of indication information may be received by the terminal, or may be generated by the terminal itself.

Case 1: The network device sends the first information, and correspondingly, the terminal receives the first information.

For example, the network device may perform error correction encoding on a first to-be-encoded sequence, for example, perform error correction encoding (for example, single-stage error correction encoding or concatenated multi-stage error correction encoding) on the first to-be-encoded sequence based on a configuration parameter for error correction encoding, to obtain the first information. Then the network device may send the first information. In this way, the peer device (for example, the terminal) does not need to perform error correction encoding, thereby facilitating energy saving.

The first to-be-encoded sequence may be a random sequence, may be a random number, may be an identifier of the network device, or may be another sequence. A specific implementation of the first to-be-encoded sequence on a network side is not limited in this embodiment of this application. For example, the network device may randomly generate a first to-be-encoded sequence, or may locally obtain a preconfigured first to-be-encoded sequence. In addition, the first to-be-encoded sequence is merely an example name in this embodiment of this application, and may be replaced with any possible name, for example, an original bit sequence, a random bit sequence, or an input bit sequence. This is not limited.

The configuration parameter may indicate at least one of the following: a format of the to-be-encoded sequence, for example, an encoding input length, or a format of indication information obtained through error correction encoding, for example, an output code length, or may be understood as an execution rule required by the network device to perform error correction encoding, or a format of information obtained through error correction encoding, for example, an encoding output length. For example, the network device may generate/obtain a to-be-encoded sequence of a corresponding length based on the encoding input length. For another example, the network device may alternatively configure, based on the encoding output length, a function needed for performing error correction encoding, for example, a matrix parameter of a position mapping matrix (denoted as π) in polar coding, to ensure that a bit sequence of a corresponding length can be output through error correction encoding.

The following separately describes how the network device performs single-stage error correction encoding or performs concatenated multi-stage error correction encoding.

### Manner 1: Single-Stage Error Correction Encoding

The first-to-be encoded sequence may be denoted as b, where b∈

$${F}_{2}^{L \times 1}$$

is a random bit sequence, and L≤CNₚ. A check function [symbol] (·) is a coding function having check and error correction capabilities, and may represent the foregoing one-stage channel error correction encoding or one-stage check coding. In this case, error correction encoding performed by the network device on the first to-be-encoded sequence based on the configuration parameter for error correction encoding may be represented as: [symbol] (b)=c, where c is an output of the check function [symbol] (·), that is, the foregoing bit sequence.

It may be understood that if N=1, that is, if the first information includes only one bit sequence, the network device may obtain the first information by performing the single-stage error correction encoding once. If N>1, that is, if the first information includes a plurality of bit sequences, the network device may repeatedly perform the single-stage error correction encoding for a plurality of times, to obtain the first information. Check functions [symbol] ₙ(·) of different single-stage error correction encoding may be the same or different. For example, [symbol] ₁(·), [symbol] ₂(·), . . . , [symbol] ₙ(·), where n is an integer greater than 1 and represents the number of times that single-stage error correction encoding is repeatedly performed, a check function [symbol] ₁(·) may represent polar coding in channel error correction encoding, a check function [symbol] ₂(·) may represent CRC check coding in check coding, and so on. Details are not described again.

It may be further understood that the check function [symbol] (·) is applicable to all users on a same scheduling-free resource, or all terminals that use the scheduling-free resource. In other words, the network device may use the same check function [symbol] (·) to generate bit sequences for these terminals, but different terminals may correspond to different first to-be-encoded sequences, to finally obtain different first information, so that different terminals can reuse different reference signals.

For ease of understanding, the foregoing example is still used for description.

In a case of CRC check coding, for example, the encoding input length may be set to 8 bits, and the encoding output length may be set to 16 bits, or [symbol] (·) may be set to an 8-bit CRC check function, for example, [symbol] (·)=X⁸+X⁵+X⁴+1. If the 8-bit first to-be-encoded sequence is represented as 0x34, the network device performs CRC check coding on the first to-be-encoded sequence once, and an obtained CRC code may be 0x34DF, which is converted in binary notation and represented as 0011010011011111, that is, the first information. For another example, alternatively, the encoding input length may be set to 4 bits, the encoding output length may be set to 8 bits, and [symbol] (·) is a 4-bit CRC check function. In this case, the network device performs CRC check coding on the 4-bit first to-be-encoded sequence once, and an obtained CRC code may be converted in binary notation and represented as 00110100.

In a case of polar coding, for example, the encoding input length may be set to 8 bits, the encoding output length may be set to 16 bits, and a related parameter needed for performing polar coding may be set. For example, a generator matrix is

$${G}_{16} = {( {G}_{2} )}^{⊗ 4} , {G}_{2} = [ \begin{matrix}1 & 0 \\ 1 & 1\end{matrix} ] ,$$

and a check function [symbol] (·) may be represented as G₁₆u, where u=π(b, 0_{1×8}) and indicates that a sequence u is a 16-bit sequence obtained by padding the 8-bit first to-be-encoded sequence with an all-zero 8-bit sequence. π is a position mapping matrix and indicates that b and 0_{1×8} are mapped to sequence positions specified in the sequence u. In this way, if the 8-bit first to-be-encoded sequence is represented as 0x34, the network device performs polar coding on the first to-be-encoded sequence once, and an obtained polar code may also be 0x34DF, which is also converted in binary notation and represented as 0011010011011111, that is, the first information. For another example, alternatively, the encoding input length may be set to 4 bits, the encoding output length may be set to 8 bits, and a related parameter needed for performing polar coding may be set. For example, a generator matrix is

$${G}_{16} = {( {G}_{2} )}^{⊗ 4} , {G}_{2} = [ \begin{matrix}1 & 0 \\ 1 & 1\end{matrix} ] ,$$

and a check function [symbol] (·) may be represented as G₁₆u, where u=π(b, 0_{1×4}) and indicates that a sequence u is an 8-bit sequence obtained by padding the 4-bit first to-be-encoded sequence with an all-zero 4-bit sequence. π is a position mapping matrix and indicates that b and 0_{1×4} are mapped to sequence positions specified in the sequence u. In this way, the network device performs polar coding on the to-be-encoded sequence once by using four bits, and an obtained polar code may be converted in binary notation and represented as 11011111.

### Manner 2: Concatenated Multi-Stage Error Correction Encoding

The first to-be-encoded sequence may still be represented as b, and a difference lies in a check function [symbol] (·)=( [symbol] ₙ . . . ( [symbol] ₂( [symbol] ₁(·)))), where n is an integer greater than 1 and represents concatenated multi-stage error correction encoding. For example, [symbol] (·)=( [symbol] ₂( [symbol] ₁(·))), where a check function [symbol] ₁(·) represents polar coding in channel error correction encoding. A check function F₂(·) represents CRC check coding in check coding. In this case, [symbol] (·) indicates that error correction encoding is concatenated polar coding and CRC check coding. In other words, the network device may first perform polar coding on the first to-be-encoded sequence to obtain a polar code, and then perform CRC check coding on the polar code to obtain a CRC code.

It may be understood that if N=1, that is, if the first information includes only one bit sequence, the network device may obtain the first information by performing the foregoing concatenated multi-stage error correction encoding once. If N>1, that is, if the first information includes a plurality of bit sequences, the network device may repeatedly perform the foregoing concatenated multi-stage error correction encoding for a plurality of times, to obtain the first information. The check functions [symbol] (·) of different concatenated multi-stage error correction encoding may be the same or different. This is not limited.

In this embodiment of this application, the terminal may receive the first information, and divide the first information into M segments, to obtain the M segments of the first information. Each of the M segments is one piece of indication information, and there are a total of M pieces of indication information.

Optionally, the network device may further send position information. Correspondingly, the terminal may further receive the position information. The position information and the first information may be carried in a same message, or may be carried in different messages. This is not limited. The position information may indicate a position of the M segments in the first information. For example, the position information may include a quantity mj of segments into which the j^{th} bit sequence is equally divided. In this case, if there is only one bit sequence, mj=M, to implicitly indicate positions of the M pieces of indication information in the first information. Alternatively, the position information may include a segment number (such as the foregoing c_{p,i}) of an i^{th} bitmap in each bit sequence and a segment resource position of the i^{th} bitmap, to indicate that x^{th} to y^{th} bits in the bit sequence are the i^{th} bitmap, that is, indicate the positions of the M pieces of indication information in the first information, where x and y are positive integers with different values. In this way, the terminal may divide the first information into M segments based on the position information, to obtain the M pieces of indication information, to avoid using an incorrect reference signal caused by a segmentation error.

It should be understood that the position information is optional information. If a segmentation rule is preconfigured in the terminal or predefined in a protocol, the network device does not need to send the position information, and the terminal does not need to receive the position information.

Case 2: The network device sends the M pieces of indication information, and correspondingly, the terminal receives the M pieces of indication information.

For example, the network device may perform error correction encoding on a first to-be-encoded sequence, for example, perform error correction encoding (for example, single-stage error correction encoding or concatenated multi-stage error correction encoding) on the first to-be-encoded sequence based on a configuration parameter for error correction encoding, to obtain the first information. The network device may divide the first information into M segments to obtain the M pieces of indication information. For a specific implementation principle, refer to related descriptions in the foregoing case 1. Details are not described herein again. For another example, the network device may directly generate the M pieces of indication information without performing segmentation. For example, error correction encoding is separately performed on M different first to-be-encoded sequences. In this case, one piece of indication information may be obtained by performing error correction encoding on each first to-be-encoded sequence, and there are a total of M pieces of indication information. In this way, the network device may send the M pieces of indication information, for example, M segments with independent bitmaps. In this way, the peer device (such as the terminal) does not need to perform error correction encoding, and does not need to perform a segmentation operation either, which further facilitates energy saving.

Case 3: The network device sends a plurality of pieces of information, and correspondingly, the terminal receives the plurality of pieces of information.

The network device may separately perform error correction encoding on the plurality of to-be-encoded sequences, to obtain and send a plurality of pieces of information. The plurality of pieces of information include the first information, and the plurality of pieces of information respectively indicate the reference signals corresponding to the scheduling-free resource. In addition, a principle of performing error correction encoding on each to-be-encoded sequence by the network device is similar to the foregoing. For details, refer to related descriptions in the foregoing case 1. Details are not described herein again.

It should be understood that the plurality of pieces of information are usually information configured for a plurality of devices (for example, a plurality of terminals), and may be sent at a time. For example, the network device may broadcast the plurality of pieces of information at a time, so that different terminals can separately obtain required information through a single broadcast. Compared with a manner of separately unicasting to the plurality of terminals, communication overheads can be reduced. Certainly, the network device also unicasts the plurality of pieces of information to the specified terminal. This is not limited.

Optionally, the network device may further send an information index. The information index indicates the first information in the plurality of pieces of information. In other words, the network device may alternatively determine which piece of information in the plurality of pieces of information is to be used by each of different terminals, to avoid a transmission collision caused by use of the same information by different terminals.

For ease of understanding, the foregoing example is still used for description.

A 16-bit bit sequence is used as an example. An example of a plurality of pieces of information may be shown in Table 2.

TABLE 2

| Information index (c_{index}) | Information (c) |
|---|---|
| 0x01 | 0011010011011111 |
| 0x02 | 1111011011011111 |
| 0x03 | 0011010010011011 |
| 0x04 | 1011001111010011 |
| . . . | . . . |

An 8-bit bit sequence is used as an example. Another example of a plurality of pieces of information may be shown in Table 3.

TABLE 3

| Information index (c_{index}) | Information (c) |
|---|---|
| 0x01 | 00110100 |
| 0x02 | 11011111 |
| 0x03 | 00110100 |
| 0x04 | 10011011 |
| . . . | . . . |

As shown in Table 2 and Table 3, each indication information index may indicate a bit sequence included in a corresponding piece of information in a plurality of pieces of information. For example, an indication information index 0x01 in Table 2 may indicate a bit sequence 0011010011011111, and an indication information index 0x02 in Table 3 may indicate a bit sequence 11011111.

Table 2 is used as an example. If an information index sent by the network device is 0x01, the terminal queries Table 2 based on 0x01, and determines that the first information includes one bit sequence: 0011010011011111. Table 3 is used as an example. If information indexes sent by the network device are 0x01 and 0x02, the terminal queries Table 3 based on 0x01 and 0x02, and determines that the first information includes two bit sequences: 00110100 and 11011111.

It should be understood that the information index is optional information. If the network device does not send the information index, the terminal may also determine the information index by itself. For example, the terminal may generate one or more random bit sequences by itself, and determine, based on each random bit sequence, an information index corresponding to the random bit sequence, for example, c_{index}=bin2Dec(B), where bin2Dec( ) represents a binary-to-decimal conversion operation, and B is a random bit sequence. In this way, the terminal may also determine, from the plurality of pieces of information based on the information index, information corresponding to the information index, for example, the first information.

It may be understood that, in the foregoing case 1 to case 3, if the terminal is a single terminal, the first information may be applicable only to the terminal, and indication information applicable to different terminals may be different. Alternatively, if the terminal is a member of a group, the first information is applicable to the group, that is, the same information is applicable to all terminals in the group.

Case 4: The terminal determines the M pieces of indication information.

For example, the terminal obtains the first information through error correction encoding. Further, the terminal may perform error correction encoding on a first to-be-encoded sequence, for example, perform error correction encoding on the first to-be-encoded sequence based on a configuration parameter needed for error correction encoding, to obtain the first information.

The first to-be-encoded sequence may be obtained by the terminal from the network device. For example, the network device may send the first to-be-encoded sequence. Correspondingly, the terminal may receive the first to-be-encoded sequence, to avoid processing overheads caused by self-determining. Alternatively, the terminal itself may determine the first to-be-encoded sequence, to avoid generating additional communication overheads.

For example, the terminal may determine a sequence corresponding to related information of the terminal as the first to-be-encoded sequence. The related information of the terminal may be at least one of the following: a random number generated by the terminal itself, or an identifier of the terminal, such as a subscription permanent identifier (SUPI) or an international mobile subscriber identity (IMSI), or the related information of the terminal may further include any other information, which may not be restricted by the network device. This is not specifically limited. The sequence corresponding to the related information of the terminal may be understood as a binary representation of the related information of the terminal. The terminal may directly determine the encoded sequence as the first to-be-encoded sequence, or may determine a part of the encoded sequence as the first to-be-encoded sequence.

It may be understood that the terminal may generate a random number once, and the random number may remain unchanged. For example, the random number may be used for error correction encoding each time the terminal performs scheduling-free transmission. Alternatively, the terminal may dynamically generate a random number. For example, a newly generated random number is used for error correction encoding each time the terminal performs scheduling-free transmission.

For another example, the terminal may determine a sequence corresponding to to-be-sent data as the first to-be-encoded sequence. The to-be-sent data may be data that needs to be sent in current scheduling-free transmission, that is, data is carried by using a reference signal, to reduce communication overheads. Further, the to-be-sent data may be bits of information elements (or information element bits) at different positions, so that the terminal determines a sequence formed by these information elements as the to-be-encoded sequence. Alternatively, the to-be-sent data may be a sequence obtained after the foregoing information elements are processed, so that the terminal determines the processed sequence as the to-be-encoded sequence. For example, the processed sequence may be a sequence that is output after a TB-CRC check, a sequence that is output after same or different CB coding, or a sequence that is punctured (or is not transmitted) after CB coding. LDPC coding is used as an example. The terminal may determine bits of key information by using a density evolution algorithm, and determine a sequence constructed by punctured bits in these bits as the to-be-encoded sequence, so that the to-be-encoded sequence can be subsequently carried by a reference signal. In this way, decoding convergence can be accelerated, and decoding performance can be improved.

In addition, source information (for example, a generation manner, extraction positions, and a combination manner after extraction) of the to-be-sent data may be configured by the network device, or may be predefined in a protocol. Regardless of which manner is used, the network device is aligned with the terminal, so that the network device can demodulate the to-be-sent data.

The configuration parameter may alternatively be obtained by the terminal from the network device. For example, the network device may send the configuration parameter, and correspondingly, the terminal may receive the configuration parameter. Alternatively, the configuration parameter may be preconfigured or predefined in a protocol on the terminal locally. In this case, the network device does not need to send the configuration parameter, and the terminal does not need to receive the configuration parameter.

It should be understood that, because the encoding input length and the encoding output length that are indicated by the configuration parameter may be aligned in advance between the terminal and the network device, the terminal performs error correction encoding based on the configuration information, for example, a predetermined encoding input length and encoding output length, to avoid decoding failure caused by an incorrect encoding format.

In addition, when both the first to-be-encoded sequence and the configuration parameter are obtained from the network device, the first to-be-encoded sequence and the configuration parameter may be carried in a same message, to reduce the number of communication times and reduce communication overheads, or may be separately carried in different messages to achieve decoupling and more flexible transmission of information elements.

It may be further understood that a principle of performing, by the terminal, error correction encoding on the first to-be-encoded sequence is similar to that in the foregoing case 1. For details, refer to the description. The details are not described again. In addition, after obtaining the first information, the terminal may further divide the first information into M segments, to obtain the M pieces of indication information. A principle thereof is similar to that in the foregoing case 1. For details, refer to the description. The details are not described again.

It may be further understood that a difference between the foregoing cases 1 to 3 and the case 4 lies in that if the network device generates and configures the corresponding indication information for the terminal, the network device can learn that the terminal corresponds to the indication information. In this case, when receiving the reference signal, the network device may determine, based on the indication information corresponding to the reference signal, the terminal from which the reference signal comes. However, if the terminal generates the indication information by itself, different terminals may also generate same indication information. Therefore, the network device may be unable to distinguish between the terminals by using the indication information. In this case, the network device may perform upper-layer decoding on data (for example, an identifier of a terminal carried in the data) in scheduling-free transmission, to distinguish between the terminals.

Optionally, with reference to the foregoing case 1 to case 4, the network device may further dynamically configure complexity of error correction encoding, and then perform or configure the complexity for the terminal, to adapt to different scenario requirements. If error correction encoding is more complex, for example, if complexity of the check function [symbol] (·) is higher, an error correction capability is stronger and a processing delay is longer; otherwise, the error correction capability is weaker and the processing delay is shorter.

For example, in a low-load scenario, there are few user access requirements and few pilot collisions, and high-complexity error correction encoding causes an excessively long access delay. Therefore, error correction encoding with relatively low complexity needs to be used. For another example, in a high-load scenario, there are many user access requirements, and pilot collisions are severe. Low-complexity error correction encoding may be unable to correct a complex error pattern, affecting user access. Therefore, error correction encoding with relatively high complexity and a relatively strong error correction capability needs to be used. Therefore, the network device may preset a plurality of check functions [symbol] ᵢ(·) having different error correction capabilities, to handle collision requirements in different scenarios. For example, a check function [symbol] ₓ(·) corresponds to the low-load scenario, and a check function [symbol] _{y}(·) corresponds to the high-load scenario. In this way, the network device may select appropriate [symbol] ᵢ(·) based on a network load level. For example, when the network load level is higher than a preset threshold, the network device may select [symbol] ᵢ(·)= [symbol] _{y}(·); otherwise, when the network load level is lower than the preset threshold, the network device may select [symbol] ᵢ(·)= [symbol] ₓ(·).

It may be further understood that [symbol] ₓ(·) and [symbol] _{y}(·) may be different error correction encoding, for example, repetition codes of a same length or RM codes. Alternatively, [symbol] ₓ(·) and [symbol] _{y}(·) may be different code rate designs in same error correction encoding. For example, Rm(1,3) and Rm(2,3) have a same code length but different code rates, which are 0.5 and 0.875 respectively, to support eight different terminals (or users).

S402: When the network device combines the bitmaps corresponding to the received reference signals, if the network device does not know a length of the bit sequence obtained through error correction encoding, the network device may combine, in an exhaustive manner, bitmaps corresponding to different quantities of time-frequency resources, for example, combine bitmaps corresponding to reference signals received on two time-frequency resources, combine bitmaps corresponding to reference signals received on three time-frequency resources, and combine bitmaps corresponding to reference signals received on four time-frequency resources, to obtain a plurality of bit sequences of different lengths. If the network device knows the length of the bit sequence obtained in advance through error correction encoding, the network device may determine a quantity of time-frequency resources corresponding to the length, and combine bitmaps corresponding to the quantity of time-frequency resources, for example, combine bitmaps corresponding to reference signals received on four time-frequency resources, to obtain a plurality of bit sequences of the length.

The network device may perform error correction decoding on the plurality of bit sequences obtained through the combination. The error correction decoding may be represented by using a decoding function [symbol] ⁻¹(·). The error correction decoding may correspond to the foregoing error correction encoding, and include at least one of the following: linear channel error correction decoding, nonlinear channel error correction decoding, or check decoding. For example, the linear channel error correction decoding may include any one of the following: an RM code, a polar code, and a low-density parity-check code. For another example, the nonlinear channel error correction decoding may include a hash code. The check decoding may include a CRC code. If the error correction encoding is single-stage error correction encoding, the network device performs single-stage error correction decoding corresponding to the single-stage error correction encoding. For example, if the error correction encoding is CRC coding, the network device performs CRC decoding on each of the plurality of bit sequences. If the error correction encoding is concatenated multi-stage error correction encoding, the network device performs concatenated multi-stage error correction decoding corresponding to the concatenated multi-stage error correction encoding. For example, if the concatenated multi-stage error correction encoding is CRC coding followed by RM coding, CRC coding followed by polar coding, or CRC coding followed by LDPC coding, the network device may perform RM decoding or polar decoding or LDPC decoding first, and then CRC decoding.

If the bit sequence obtained through the combination corresponds to (for example, is the same as or similar to) the bit sequence obtained through error correction encoding, the bit sequence obtained through error correction encoding, that is, the first information, can be obtained through error correction decoding. Otherwise, error correction decoding cannot output a result.

For ease of understanding, the foregoing example is still used for description.

The network device receives {reference signal 1, reference signal 3, reference signal 5} on the RB 1, the network device receives {reference signal 4, reference signal 11, reference signal 8} on the RB 2, the network device receives {reference signal 15, reference signal 2, reference signal 13} on the RB 3, and the network device receives {reference signal 7, reference signal 15, reference signal 12} on the RB 4.

If the network device does not know the length of the bit sequence obtained through error correction encoding, the network device may separately perform combination at a granularity of two RBs, a granularity of three RBs, and a granularity of four RBs, to obtain a plurality of bit sequences whose lengths are respectively 8 bits, 12 bits, and 16 bits. Alternatively, if the network device knows the length of the bit sequence obtained through error correction encoding, the network device may perform combination at a granularity of the determined quantity of RBs. For example, if the length is eight bits, and a bitmap corresponding to each RB is four bits, combination needs to be performed at a granularity of two RBs, to obtain a plurality of bit sequences whose lengths are eight bits. For another example, if the length is 16 bits, and a bitmap corresponding to each RB is four bits, combination needs to be performed at a granularity of four RBs, to obtain a plurality of bit sequences whose lengths are 16 bits.

Then, in a process of performing error correction decoding, if N=1, for a bit sequence obtained by combining respective bitmaps of {reference signal 3 on RB 1, reference signal 4 on RB 2, reference signal 13 on RB 3, reference signal 15 on RB 4}, error correction decoding can be normally performed on the bit sequence, or in other words, verification of the check function [symbol] (·) succeeds, and 0011010011011111 is output. Alternatively, if N=2, for a bit sequence obtained by combining respective bitmaps of {reference signal 3 on RB 1, reference signal 4 on RB 2}, error correction decoding can be performed on the bit sequence, and 00110100 is output. Similarly, for a bit sequence obtained by combining respective bitmaps of {reference signal 13 on RB 3, reference signal 15 on RB 4}, error correction decoding can be performed on the bit sequence, and 11011111 is output. However, for a bit sequence obtained by combining respective bitmaps of {reference signal 1 on RB 1, reference signal 3 on RB 2, reference signal 15 on RB 3, reference signal 7 on RB 4}, error correction decoding cannot be performed on the bit sequence, and no result can be output.

It may be understood that error correction decoding has an error correction function. For example, a bit error that occurs in a scheduling-free transmission process may be corrected, so that a correct bit is obtained. Therefore, a burst error can be resisted, error propagation can be reduced, and false alarms and missed detection can be avoided. An RM code is used as an example. Setting [symbol] (·)=Rm(1,2)=(4,3) means that for each terminal, two bit errors can be detected and one bit error can be corrected. For a multi-terminal scenario in which there are four RBs and each RB supports two reference signals, for example, a scenario with eight terminals, a pattern of reference signals of the eight terminals before error correction may be shown in FIG. 5, and a pattern of reference signals after error correction may be shown in FIG. 6. 0 and 1 in FIG. 5 and FIG. 6 respectively represent a reference signal 0 and a reference signal 1.

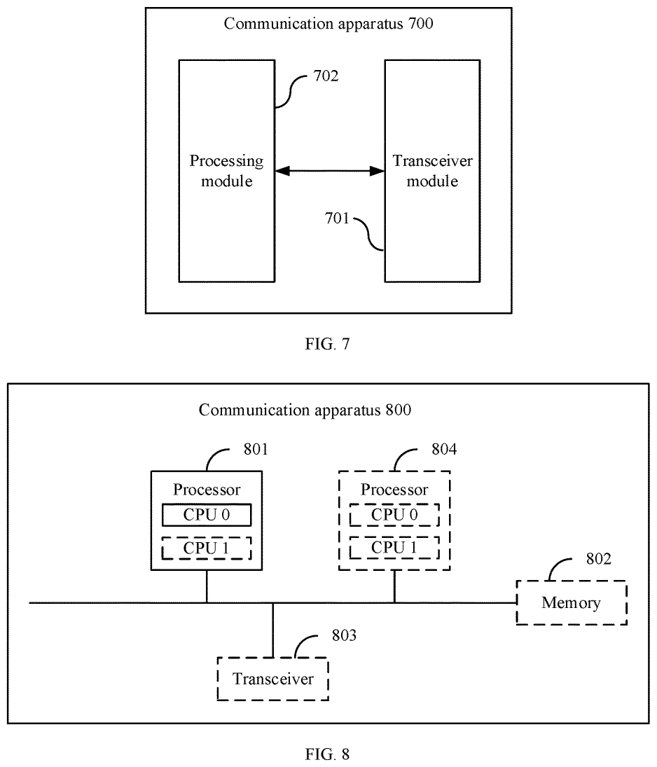

The methods provided in embodiments of this application are described above in detail with reference to FIG. 4 to FIG. 6. Communication apparatuses configured to perform the communication methods provided in embodiments of this application are described below in detail with reference to FIG. 7 and FIG. 8.

FIG. 7 is a diagram 1 of a structure of a communication apparatus according to an embodiment of this application. For example, as shown in FIG. 7, a communication apparatus 700 includes a transceiver module 701 and a processing module 702. For ease of description, FIG. 7 shows only main components of the communication apparatus.

The transceiver module 701 is configured to perform receiving and sending functions in the method shown in FIG. 4, and the processing module 702 is configured to perform a function in the method shown in FIG. 4 other than the receiving and sending functions.

Optionally, the transceiver module 701 may include a sending module (not shown in FIG. 7) and a receiving module (not shown in FIG. 7). The sending module is configured to implement a sending function of the communication apparatus 700, and the receiving module is configured to implement a receiving function of the communication apparatus 700.

Optionally, the communication apparatus 700 may further include a storage module (not shown in FIG. 7), and the storage module stores a program or instructions. When the processing module 702 executes the program or the instructions, the communication apparatus 700 is enabled to perform the functions of the terminal or the network device in the methods shown in FIG. 4 to FIG. 6.

It may be understood that the communication apparatus 700 may be a terminal or a network device, may be a chip (system) or another part or component that may be disposed in a terminal or a network device, or may be an apparatus that includes a terminal or a network device. This is not limited in this application.

In addition, for technical effects of the communication apparatus 700, refer to the technical effects of the methods shown in FIG. 4 to FIG. 6. Details are not described herein again.

FIG. 8 is a diagram 2 of a structure of a communication apparatus according to an embodiment of this application. For example, the communication apparatus may be a terminal, or may be a chip (system) or another component or part that may be disposed in a terminal. As shown in FIG. 8, the communication apparatus 800 may include a processor 801. Optionally, the communication apparatus 800 may further include a memory 802 and/or a transceiver 803. The processor 801 is coupled to the memory 802 and the transceiver 803, for example, may be connected to the memory 802 and the transceiver 803 through a communication bus.

The following describes the components of the communication apparatus 800 in detail with reference to FIG. 8.

The processor 801 is a control center of the communication apparatus 800, and may be one processor or may be a collective term for a plurality of processing elements. For example, the processor 801 is one or more central processing units (CPUs), or may be an application-specific integrated circuit (ASIC), or is configured as one or more integrated circuits for implementing embodiments of this application, for example, one or more microprocessors (digital signal processors (DSPs)) or one or more field-programmable gate arrays (FPGAs).

Optionally, the processor 801 may perform various functions of the communication apparatus 800 by running or executing a software program stored in the memory 802 and invoking data stored in the memory 802, for example, perform the communication method shown in FIG. 4.

During specific implementation, in an embodiment, the processor 801 may include one or more CPUs, for example, a CPU 0 and a CPU 1 shown in FIG. 8.

During specific implementation, in an embodiment, the communication apparatus 800 may alternatively include a plurality of processors, for example, the processor 801 and a processor 804 shown in FIG. 8. Each of the processors may be a single-core processor (single-CPU) or may be a multi-core processor (multi-CPU). The processor herein may be one or more devices, circuits, and/or processing cores configured to process data (for example, computer program instructions).

The memory 802 is configured to store the software program for performing the solutions in this application, and the processor 801 controls the execution. For a specific implementation, refer to the foregoing method embodiments. Details are not described herein again.

Optionally, the memory 802 may be a read-only memory (ROM) or another type of static storage device that can store static information and/or instructions, or may be a random-access memory (RAM) or another type of dynamic storage device that can store information and instructions, or may be an electrically erasable programmable ROM (EEPROM), a compact disc (CD) ROM or another compact disc storage, an optical disc storage (including a compact disc, a laser disc, an optical disc, a digital versatile disc (DVD), a BLU-RAY disc, or the like), a magnetic disk storage medium or another magnetic storage device, or any other medium that can be used to carry or store desired program code in a form of instruction or a data structure and can be accessed by a computer. This is not limited. The memory 802 may be integrated with the processor 801, or may exist independently and is coupled to the processor 801 through an interface circuit (not shown in FIG. 8) of the communication apparatus 800. This is not specifically limited in embodiments of this application.

The transceiver 803 is configured to communicate with another communication apparatus. For example, the communication apparatus 800 is a terminal device, and the transceiver 803 may be configured to communicate with a network device or communicate with another terminal device. For another example, the communication apparatus 800 is a network device, and the transceiver 803 may be configured to communicate with a terminal or communicate with another network device.

Optionally, the transceiver 803 may include a receiver and a transmitter (not separately shown in FIG. 8). The receiver is configured to implement a receiving function, and the transmitter is configured to implement a sending function.

Optionally, the transceiver 803 may be integrated with the processor 801, or may exist independently and is coupled to the processor 801 through an interface circuit (not shown in FIG. 8) of the communication apparatus 800. This is not specifically limited in embodiments of this application.

It may be understood that the structure of the communication apparatus 800 shown in FIG. 8 does not constitute a limitation on the communication apparatus. An actual communication apparatus may include more or fewer components than those shown in the figure, or combine some components, or have different component arrangements.

In addition, for technical effects of the communication apparatus 800, refer to the technical effects of the methods in the foregoing method embodiments. Details are not described herein again.

An embodiment of this application further provides a chip. The chip includes at least one controller and at least one interface circuit. The at least one controller and the at least one interface circuit may be interconnected through a line. The controller is configured to support a chip system in implementing functions or steps in the foregoing method embodiments. The at least one interface circuit may be configured to receive a signal from another apparatus (for example, a communication interface, a radio frequency generation circuit, a power amplification system, or an antenna), or send a signal to another apparatus (for example, a communication interface, a radio frequency generation circuit, a power amplification system, or an antenna). The chip system may include a chip, and may further include another discrete component.

It should be understood that, the processor in embodiments of this application may be a CPU, or may be another general-purpose processor, a DSP, an ASIC, a FPGA or another programmable logic device, a discrete gate or transistor logic device, a discrete hardware component, or the like. The general-purpose processor may be a microprocessor, or the processor may be any processor or the like.

It should be further understood that the memory in embodiments of this application may be a volatile memory or a nonvolatile memory, or may include a volatile memory and a nonvolatile memory. The non-volatile memory may be a ROM, a PROM, an erasable PROM (EPROM), and an EEPROM, or a flash memory. The volatile memory may be a RAM, used as an external cache. Through illustrative but not limitative description, many forms of RAMs may be used, for example, a static RAM (SRAM), a dynamic RAM (DRAM), a synchronous DRAM (SDRAM), a double data rate (DDR) SDRAM, an enhanced SDRAM (ESDRAM), a synchronous link DRAM (SLDRAM), and a direct Rambus (DR) RAM.

All or some of the foregoing embodiments may be implemented by using software, hardware (for example, circuit), firmware, or any other combination thereof. When software is used to implement embodiments, all or some of the foregoing embodiments may be implemented in a form of a computer program product. The computer program product includes one or more computer instructions or computer programs. When the computer instructions or the computer programs are loaded and executed on a computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from one computer-readable storage medium to another computer-readable storage medium. For example, the computer instructions may be transmitted from a website, computer, server, or data center to another website, computer, server, or data center in a wired (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that the term “and/or” in this specification describes only an association relationship between associated objects, and represents that three relationships may exist. For example, A and/or B may represent the following three cases: A exists alone, both A and B exist, and B exists alone, where A and B may be singular or plural. In addition, the character “/” in this specification usually indicates an “or” relationship between the associated objects, but may also indicate an “and/or” relationship. For details, refer to the context for understanding.

In this application, “at least one” means one or more, and “a plurality of” means two or more. The term “at least one of the following items (pieces)” or an expression similar to the term indicates any combination of these items, including a singular item (piece) or any combination of plural items (pieces). For example, at least one item (piece) of a, b, or c may indicate a, b, c, a and b, a and c, b and c, or a, b, and c, where a, b, and c may be singular or plural.

It should be understood that sequence numbers of the foregoing processes do not mean execution orders in various embodiments of this application. The execution orders of the processes should be determined based on functions and internal logic of the processes, but should not be construed as any limitation on the implementation processes of embodiments of this application.

A person of ordinary skill in the art may be aware that units and algorithm steps in the examples described with reference to embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

A person skilled in the art may clearly understand that, for the purpose of convenient and brief description, for a detailed working process of the foregoing system, apparatus, and unit, refer to a corresponding process in the foregoing method embodiments. Details are not described herein again.

In several embodiments provided in this application, it should be understood that the disclosed system, apparatus, and method may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected based on actual requirements to achieve the objectives of the solutions in embodiments.

In addition, functional units in embodiments of this application may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the existing related technology, or a part of the technical solutions may be embodied in a form of a software product. The computer software product is stored in a storage medium, and includes several instructions for enabling a computer device (which may be a personal computer, a server, a network device, or the like) to perform all or some of the steps of the methods described in embodiments of this application. The storage medium includes any medium that can store program code, for example, a Universal Serial Bus (USB) flash drive, a removable hard disk, a ROM, a RAM, a magnetic disk, or an optical disc.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A method comprising:
obtaining first information through error correction encoding;
dividing the first information into M segments, wherein M is an integer greater than 1,
determining M pieces of indication information that are in a one-to-one correspondence with the M segments and that indicate M reference signals corresponding to a scheduling-free resource; and
sending the M reference signals on the scheduling-free resource based on the M pieces of indication information.

2. The method of claim 1, wherein obtaining the first information comprises performing the error correction encoding on a first-to-be-encoded sequence to obtain the first information, and wherein the error correction encoding comprises at least one of linear channel error correction encoding, nonlinear channel error correction encoding, or check coding.

3. The method of claim 2, wherein performing the error correction encoding comprises performing based on a configuration parameter, the error correction encoding.

4. The method of claim 2, further comprising:
receiving the to-be-encoded sequence; or
determining the to-be-encoded sequence by determining a sequence corresponding to to-be-sent data as the to-be-encoded sequence.

5. The method of claim 1, further comprising receiving position information indicating a position of the M segments in the first information, and wherein determining the M pieces of indication information comprises dividing, based on the position information, the first information into the M segments to obtain the M pieces of indication information.

6. The method of claim 1, wherein the scheduling-free resource comprises M time-frequency resources, and wherein each of the M time-frequency resources carries a corresponding reference signal in the M reference signals.

7. The method of claim 6, further comprising receiving a correspondence between the M time-frequency resources and the M pieces of indication information, and wherein sending the M reference signals comprises sending the M reference signals on the M time-frequency resources based on the M pieces of indication information and the correspondence.

8. The method of claim 1, wherein the first information comprises N bit sequences, wherein N is a positive integer, and wherein the method further comprises:
obtaining the M segments by dividing a j^{th} bit sequence in the N bit sequences into mj segments, wherein j traverses 1 to N; and
using one bitmap in each of the M segments as one piece of indication information, wherein the j^{th} bit sequence is expressed as:
$${c}_{j} = [ {c}_{p , 1} , … {c}_{p , i} … , {c}_{p , mj} ] ∈ {F}_{2}^{{CN}_{p} \times 1} ,$$
wherein cⱼ represents the j^{th} bit sequence, wherein c_{p,i} represents an i^{th} bitmap, wherein i is any integer from 1 to mj, wherein F₂ represents a binary finite field, wherein CNₚ represents that the i^{th} bitmap comprises Nₚ bits, and wherein Nₚ is an integer greater than 1.

9. A communication apparatus, comprising:
a memory configured to store instructions; and
one or more processors coupled to the memory and configured to execute the instructions to cause the communication apparatus to
obtain first information through error correction encoding;
divide the first information into M segments, wherein M is an integer greater than 1;
determine M pieces of indication information that are in a one-to-one correspondence with the M segments and that indicate M reference signals corresponding to a scheduling-free resource; and
send the M reference signals on the scheduling-free resource based on the M pieces of indication information.

10. The communication apparatus of claim 9, wherein to obtain the first information, the one or more processors are further configured to execute the instructions to cause the communication apparatus to perform the error correction encoding on a to-be-encoded sequence to obtain the first information, and wherein the error correction encoding comprises at least one of linear channel error correction encoding, nonlinear channel error correction encoding, or check coding.

11. The communication apparatus of claim 10, wherein to perform the error correction encoding, the one or more processors are further configured to execute the instructions to cause the communication apparatus to perform, based on a configuration parameter, the error correction encoding.

12. The communication apparatus of claim 10, wherein the one or more processors are further configured to execute the instructions to cause the communication apparatus to:
receive the to-be-encoded sequence; or
determine the to-be-encoded sequence by determining a sequence corresponding to to-be-sent data as the to-be-encoded sequence.

13. The communication apparatus of claim 9, wherein the one or more processors are further configured to execute the instructions to cause the communication apparatus to:
receive position information indicating a position of the M segments in the first information; and
divide, based on the position information, the first information into the M segments, to obtain the M pieces of indication information.

14. The communication apparatus of claim 9, wherein the scheduling-free resource comprises M time-frequency resources, and wherein each of the M time-frequency resources carries a corresponding reference signal in the M reference signals.

15. The communication apparatus of claim 14, wherein the one or more processors are further configured to execute the instructions to cause the communication apparatus to:
receive a correspondence between the M time-frequency resources and the M pieces of indication information; and
send the M reference signals on the M time-frequency resources based on the M pieces of indication information and the correspondence.

16. The communication apparatus of claim 9, wherein the first information comprises N bit sequences, wherein N is a positive integer, and wherein the one or more processors are further configured to execute the instructions to cause the communication apparatus to:
obtain the M segments by dividing a j^{th} bit sequence in the N bit sequences into mj segments, wherein j traverses 1 to N; and
use one bitmap in each of the M segments as one piece of indication information, wherein the j^{th} bit sequence is expressed as:
$${c}_{j} = [ {c}_{p , 1} , … {c}_{p , i} … , {c}_{p , mj} ] ∈ {F}_{2}^{{CN}_{p} \times 1} ,$$
wherein cⱼ represents the j^{th} bit sequence, wherein c_{p,i} represents an i^{th} bitmap, wherein i is any integer from 1 to mj, wherein F₂ represents a binary finite field, wherein CNₚ represents that the i^{th} bitmap comprises Nₚ bits, and wherein Nₚ is an integer greater than 1.

17. A communication apparatus, comprising:
a memory configured to store instructions; and
one or more processors coupled to the memory and configured to execute the instructions to cause the communication apparatus to
receive reference signals on a scheduling-free resource;
determine first information indicating the reference signals;
perform error correction decoding on the first information to obtain second information;
divide the second information into M segments, wherein the M segments are in a one-to-one correspondence with M pieces of indication information, wherein the M pieces of indication information indicate that the reference signals are M reference signals, and wherein M is an integer greater than 1; and
decode scheduling-free transmission using the second information.

18. The communication apparatus of claim 17, wherein before receiving the reference signals, the one or more processors are further configured to execute the instructions to cause the communication apparatus to:
perform the error correction encoding on a to-be-encoded sequence to obtain the second information;
send the second information; and
send position information indicating a position of the M segments in the second information.

19. The communication apparatus of claim 17, wherein before receiving the reference signals, the one or more processors are further configured to execute the instructions to cause the communication apparatus to:
perform the error correction encoding on a to-be-encoded sequence to obtain the second information, divide the first information into M segments to obtain the M pieces of indication information, and send the M pieces of indication information; or
separately perform error correction encoding on a plurality of to-be-encoded sequences to obtain a plurality of pieces of information, and send the plurality of pieces of information, wherein the plurality of pieces of information comprise the second information, and wherein the plurality of pieces of information respectively indicate the reference signals correspond to the scheduling-free resource.

20. The communication apparatus of claim 17, wherein the second information comprises N bit sequences, wherein N is a positive integer, wherein the one or more processors are further configured to execute the instructions to cause the communication apparatus to obtain the M segments by dividing a j^{th} bit sequence in the N bit sequences into mj segments, wherein j traverses 1 to N, and wherein one bitmap in each of the M segments is used as one piece of indication information.
